(19) United States
(12) Patent Application Publication
(10) Pub. No.: US 2008/0297047 A1
(43) Pub. Date: Dec. 4, 2008

(54) SEMICONDUCTOR LIGHT-EMITTING DEVICE

(75) Inventors: Tatsuoki Kohno, Tokyo (JP); Akiko Suzuki, Tokyo (JP); Toshihide Takahashi, Tokyo (JP); Hatsuo Takezawa, Yokohama-shi (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Kabushiki Kaisha Toshiba

(21) Appl. No.: 12/048,364

(22) Filed: Mar. 14, 2008

(30) Foreign Application Priority Data
Mar. 29, 2007 (JP) 2007-087197

(51) Int. Cl. H01J 1/62

(52) U.S. Cl. 313/512

(57) ABSTRACT

A semiconductor light-emitting device is provided, which includes a semiconductor light-emitting element which emits light, and a sealing material made from an optical transparent inorganic material and provided on the semiconductor light-emitting element. The optical transparent inorganic material contains phosphor particles and inorganic filler. The inorganic filer has an average particle diameter of 0.001 to 1 μm and is dispensed in an amount of 25 wt % or less.

### CROSS-REFERENCE TO RELATED APPLICATIONS

This application is based upon and claims the benefit of priority from prior Japanese Patent Application No. 2007-087197, filed Mar. 29, 2007, the entire contents of which are incorporated herein by reference.

### BACKGROUND OF THE INVENTION

1. Field of the Invention

The present invention relates to a semiconductor light-emitting device.

2. Description of the Related Art

In general, a semiconductor light-emitting device is configured by covering a light-emitting element such as a light-emitting diode with a resin sealing body. The resin sealing body is an organic polymer compound where elements such as carbon, hydrogen, oxygen, nitrogen or the like are bonded with one another in a net-like manner. When a resin sealing body made from a cured material of epoxy resin is irradiated with ultraviolet rays or the like, bonding of organic polymer is cut, which deteriorates the various optical characteristics and chemical characteristics thereof.

The covering resin is deteriorated by light having a short wavelength, such as ultraviolet rays generated from a light-emitting diode chip. If a sealing resin made from a cured material of an organic polymer compound is irradiated with ultraviolet rays, bonding of elements in the organic polymer is cut, which also deteriorates the various optical characteristics and chemical characteristics thereof.

A blue-color light-emitting diode chip of the GaN-type has light-emitting components in an ultraviolet wavelength region with a wavelength of 380 nm or less in addition to visible light components. A sealing resin covering such a diode chip gradually changes to a yellow color, which leads to absorption and attenuation of visible light from the diode chip. Since the moisture resistance lowers and ion permeability increases according to deterioration of the covering resin, the light-emitting diode itself deteriorates. As a result, a light-emitting intensity of the light-emitting diode device lowers in a synergistic manner. Since the covering resin with a low heat resistance changes to a yellow color, light emitted from the light-emitting diode chip attenuates when it passes through the covering resin.

For example, in a blue-color light-emitting diode chip of GaN with a high forward voltage, a large power loss occurs even in a relatively low forward voltage, so that the temperature of the light-emitting diode chip during activation rises considerably. Resin gradually deteriorates to change to a yellow color when it is heated up to a high temperature. In a conventional light-emitting diode device, when phosphor particles are added to the resin, the abovementioned problem occurs, which results in reduction of the number of kinds of materials to be selected, lowering of the reliability, imperfection of the light conversion function, and a rise in the product price.

### BRIEF SUMMARY OF THE INVENTION

A semiconductor light-emitting device according to one aspect of the present invention comprises a semiconductor light-emitting element which emits light; and a sealing material made from an optical transparent inorganic material and provided on the semiconductor light-emitting element, the optical transparent inorganic material containing phosphor particles and inorganic filler, the inorganic filer having an average particle diameter of 0.001 to 1 μm and being dispensed in an amount of 25 wt % or less.

### BRIEF DESCRIPTION OF THE SEVERAL VIEWS OF THE DRAWING

FIG. 1 is a sectional view of a semiconductor light-emitting device according to an embodiment; and

FIG. 2 is a sectional view of a semiconductor light-emitting element.

### DETAILED DESCRIPTION OF THE INVENTION

An embodiment will be explained below.

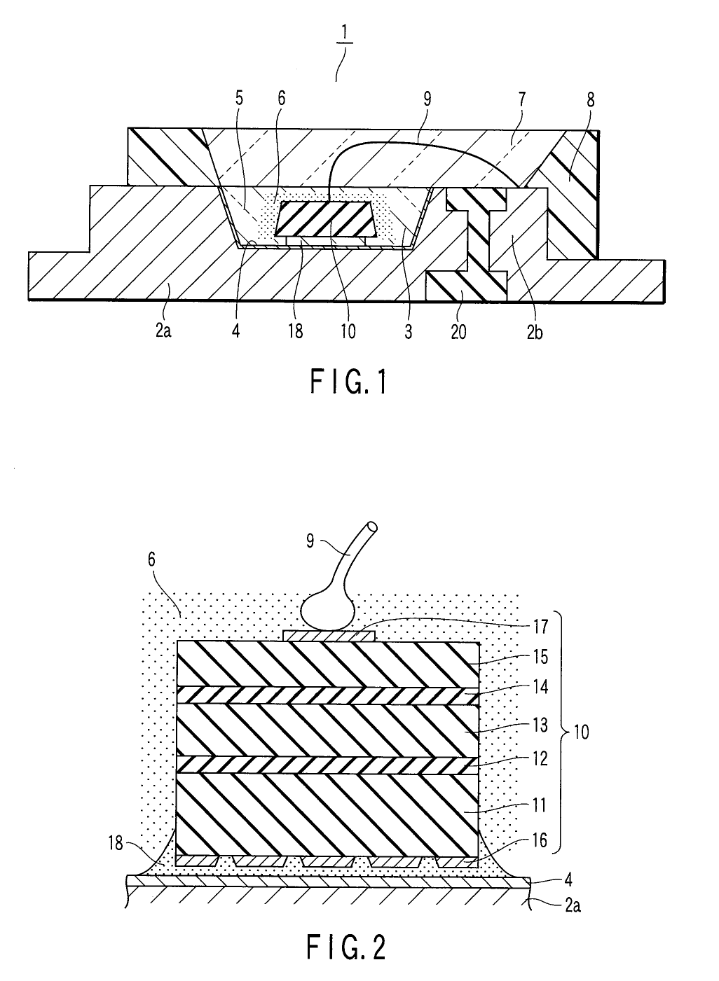

As illustrated in FIG. 1, a semiconductor light-emitting device 1 according to one embodiment is provided with a sealing material 5 made from an inorganic material, a cover resin sealing material 7, and a resin frame 8, and an LED chip 10 serving as a semiconductor light-emitting element on Cu frames 2a and 2b serving as electrically-conductive base materials. A recess serving as a mount portion 3 is formed on the Cu frame 2a. The LED chip 10 is joined to an approximately central portion of the mount portion 3 through a solder joining portion 18 of the Au-type. Incidentally, the Cu frame 2a on a negative side is insulated from the Cu frame 2b on a positive electrode side by an insulating body 20.

The LED chip 10 is joined to the mount portion 3 in the following manner. An Ag plated layer 4 serving as a base electrically-conductive layer is formed on the mount portion 3 in a coating manner by using a known plating method, and a negative electrode side of the LED chip 10 is soldered to the mount portion 3 using an Au-type soldering material (for example, Au—Su soldering alloy). Thereby, the negative electrode side of the LED chip 10 is electrically connected to a negative electrode terminal (not shown).

The sealing material 5 is filled in the mount portion 3, and the LED chip 10 is completely embedded in the sealing material 5. The thickness of the sealing material 5 is about 40 μm. The sealing material 5 is made from an optically transparent inorganic material, and phosphor particles 6 and inorganic filler (not shown) are contained in the inorganic material.

The resin frame 8 is attached to the Cu frames 2a and 2b so as to cover a light-emitting face of the device 1. The cover resin sealing material 7 is filled in the recess of the resin frame 8. The cover resin sealing material 7 covers the whole face of the sealing material 5 in the mount portion 3. Light emitted from the LED chip 10 is converted to a desired wavelength by the sealing material 5 containing the phosphor particles 6 to pass through the cover resin sealing material 7 and be emitted from the device 1 to the outside. Incidentally, the resin frame 8 is made from a white resin (for example, epoxy resin). A lens portion (not shown) for collecting light emitted from the LED chip 10 and/or light reflected by a surface of the mount portion 3 is disposed on a top portion of the cover resin sealing material 7.

The phosphor particles 6 in the sealing material 5 absorb a portion of light emitted from the LED chip 10 to perform conversion to a specific wavelength. Accordingly, the sealing material 5 functions as a wavelength converting portion.

The phosphor particles 6 contain, for example, a YAG-type ((Y, Gd)₃Al₅O₁₂):Ce³⁺, silicates: Eu²⁺, or the like, and it is preferable that particle sizes thereof are in a range of about 3 to 80 μm. Incidentally, an average particle diameter of the phosphor particles can be obtained by using such a technique as the Westergren method. The phosphor particles 6 are usually contained in the sealing material 5 in a concentration of about 5 to 80 wt %. The phosphor particles are disposed near a light-emitting face of the LED chip 10, as shown in FIG. 2.

It is preferable that the inorganic filler is made from a white or transparent material, and the filler made from, for example, SiO₂, TiO₂, or the like can be used as the inorganic filler. Preferably, at least 90 wt % of the inorganic filler is SiO₂. In this case, transparency of the sealing material is maintained, which is advantageous regarding light permeability. An average particle diameter of the inorganic filler is set to 0.001 to 1 μm. Here, the average particle diameter of the inorganic filler refers to the average value of diameters of spheres when it is assumed that the shape of the inorganic filler is sphere. For example, the average value can be obtained by a laser micro-track technique. The content of the inorganic filler in the sealing material 5 is set to 25 wt % or less.

The sealing material 5 in the light-emitting device according to the embodiment contains the inorganic filler with the average particle diameter of 0.001 to 1 μm in an amount of 25 wt % or less. Light of a high strength can be emitted due to the inorganic filler satisfying such conditions being contained in the sealing material 5. In view of a light-emitting efficiency, it is desirable that the inorganic filler is contained in the sealing material 5 in an amount of 0.001 wt % or more.

An enlargement view of the LED chip 10 is shown in FIG. 2. A structure of the LED chip 10 will be explained with reference to FIG. 2.

As illustrated in FIG. 2, an n-side electrode 16 of the LED chip 10 is electrically connected to a negative electrode terminal via the Au-type solder joined portion 18, the Ag-plated layer 4, and the Cu frame 2a. On the other hand, a p-side electrode 17 is electrically connected to a positive electrode terminal via the Cu frame 2b (not shown) by an Au wire 9 wire-bonded.

In the LED chip 10, a buffer layer 12, an n-type GaN clad layer 13, an InGaN/GaN active layer 14 and a p-type GaN clad layer 15 are sequentially stacked on an n-type SiC substrate 11. The n-type anode electrode 16 is provided on a back face side of the n-type SiC substrate 11, and the p-type cathode electrode 17 is provided on an upper face side of the p-type GaN clad layer 15. The anode electrode 16 is connected with the Cu frame 2a via the electrically-conductive solder joined portion 18 and the Ag base plated layer 4. In the cathode electrode 17, the other Cu frame 2b is connected to the Au wire 9. When a current is caused to flow between both the electrodes 16 and 17, colored light (for example, blue light) is emitted from the light-emitting face of the chip 10.

The LED chip 10 can be made from a gallium nitride compound semiconductor which emits light with a wavelength of 365 to 550 nm. In the present embodiment, a blue-color light-emitting diode chip of GaN-type having a peak light-emitting wavelength of about 440 to 470 nm is used in the LED chip 10.

The gallium nitride compound semiconductor is expressed by chemical formula In_{(1-X)}Ga_{X}N (0<x≦1), and it is formed on an insulating substrate serving as a base body made of sapphire or the like by a known epitaxial growth method or the like.

In the semiconductor light-emitting device 1, an upper face and side faces of the LED chip 10 are covered with the sealing material 5. The sealing material 5 is formed by using a sealing material forming solution containing alkoxysiloxane as a starting material (precursor). The sealing material 5 obtained is basically made from SiO₂ and it is excellent in the ultraviolet resistance property and heat resistance, so that deterioration (change to yellow, moisture absorption, heat degradation, or the like) thereof does not occur substantially even under a high temperature environment or under ultraviolet ray. Therefore, even when the sealing material 5 is irradiated with light with short wavelengths from the LED chip for a relatively long period, attenuating of the light emission from the LED chip 10 does not occur because the chemical properties of the sealing material 5 are stable. Specifically, since an inorganic material used for the sealing material 5 is a glasslike material, it contains a considerably-small amount of impurities as compared with a low-melting point glass including boron or lead oxide, and permeation of harmful substance thereof is also prevented. Accordingly, adverse influence on the properties of the semiconductor light-emitting element is avoided, so that an inexpensive semiconductor light-emitting device with high reliability can be obtained.

Even if a temperature rise due to heat generation of the LED chip 10 has occurred, deterioration which attenuates light emission from the LED chip 10 does not occur in the sealing material 5. Incidentally, there is a possibility that SiO₂ obtained by utilizing alkoxysiloxane as a starting material contains inevitable impurities in an amount of about 5 to 10 wt % or less. It is therefore preferable that at least 90 wt % of the sealing material is SiO₂.

In manufacture of the semiconductor light-emitting device according to the embodiment, the sealing material 5 is formed using a sealing material forming solution containing inorganic filler with a predetermined average particle diameter in a predetermined concentration. Since only a solution which does not contain any inorganic filler has a very low viscosity, it is very difficult to achieve formation on an upper portion of a chip, but viscosity is increased by adding a small amount of inorganic filler to the solution. As a result, it become possible to form the sealing material 5 with a sufficient thickness for covering the LED chip 10.

The sealing material formation solution which is the material for the sealing material 5 is a liquid-like, transparent sealing material formed due to decomposition of components or absorption of oxygen caused by heating the sealing material formation solution in air or in an oxygen-containing atmosphere. Sealing material containing phosphor particles having a light conversion function can be formed by mixing phosphor particles in the sealing material formation solution to apply the resultant solution so as to enclose a semiconductor light-emitting element.

In the manufacture of the sealing material 5, the sealing material formation solution containing the phosphor particles is poured into a recess from above a light-emitting diode chip. After the light-emitting diode chip is baked at a temperature of about 150 to 200° C. to solidify the sealing material containing phosphor particles, a whole end portion of an external terminal is sealed by a transparent sealing resin. The baking temperature of the sealing material is sufficiently lower than the melting point of a light-emitting diode chip joined portion.

Since sealing material 5 to be obtained is made from an inorganic material, the ultraviolet-resistance property is excellent. Changing to yellow and coloring of the cover resin sealing material 7 disposed on the sealing material 5 is excellently prevented due to the ultraviolet-resistance property of the sealing material 5.

The semiconductor light-emitting device according to the embodiment will be explained below specifically.

### EXAMPLES 1 to 11

A solution was prepared by dissolving alkoxysiloxane in isopropyl alcohol serving as a solvent in a concentration of 90 wt %. The alkoxysiloxane was specifically methylsiloxane. An inorganic mixture was prepared by dispersing strontium orthosilicate with an average particle diameter of 50 μm in the resultant solution at a concentration of 25 wt %.

Further, a sealing material formation solution was obtained by adding inorganic filler to the prepared mixture in an amount of 25 wt %. At least 99 wt % of the inorganic filler used here is SiO₂, where an average particle diameter of the inorganic filler was 0.001 μm.

Disposition to a mount portion of an electrically-conductive base member was performed using a blue-color light-emitting diode chip of the GaN-type having a peak wavelength of 455 nm as the semiconductor light-emitting element. A white semiconductor light-emitting device (hereinafter, LED) of Example 1 (No. 1) was manufactured by injecting the abovementioned sealing material formation solution into the mounting portion to perform baking at a temperature of 180° C. In the white LED obtained, the semiconductor light-emitting element was covered with a sealing material comprising SiO₂ which was inorganic material, phosphor particles dispersed in SiO₂ and inorganic filler containing.

When the emission spectrum was measured by a total luminous flux measuring apparatus, the emission color of LED of example 1 had a chromaticity value x=0.32 and y=0.31 and a color temperature of 5000K.

Various sealing material formation solutions were prepared in the same manner as a case of Example 1 except for changes of the average particle diameter and the additive amount of the inorganic filler, and LEDs of Examples 2 to 11 were manufactured by using the obtained solutions.

Outputs of the respective white LEDs were obtained by the total luminous flux measuring apparatus, and white relative values of the white LEDs of Examples 1 to 11 were calculated defining an output of an LED which was not added with any inorganic filler as 1 (Reference Example 4 described below). The results together with the average particle diameters and the additive amounts of the inorganic filler are collectively shown in the following Table 1.

TABLE 1

| | Average | | |
|---|---|---|---|
| | particle | Additive | White |
| | diameter | amount | relative |
| No. | (μm) | (wt %) | value |
| Example 1 | 0.001 | 25 | 1.6 |
| Example 2 | 0.6 | 0.5 | 1.5 |
| Example 3 | 0.005 | 10 | 1.7 |
| Example 4 | 1.0 | 0.1 | 1.4 |
| Example 5 | 0.08 | 3 | 1.5 |
| Example 6 | 0.007 | 7 | 1.8 |
| Example 7 | 0.3 | 0.8 | 1.5 |
| Example 8 | 0.1 | 1.2 | 1.6 |
| Example 9 | 0.003 | 20 | 1.7 |
| Example 10 | 0.8 | 0.25 | 1.5 |
| Example 11 | 1.0 | 25 | 1.3 |
| Reference | 0.0005 | 10 | 1.0 |
| Example 1 | | | |
| Reference | 1.1 | 10 | 0.7 |
| Example 2 | | | |
| Reference | 0.01 | 30 | 0.6 |
| Example 3 | | | |
| Reference | — | 0 | 1.0 |
| Example 4 | | | |

### REFERENCE EXAMPLES 1 to 4

Various sealing material formation solutions were prepared in the same manner as Example 1 except for changes of the average particle diameter and the additive amount of the inorganic filler, and LEDs of Reference Examples 1 to 3 were manufactured by using the obtained solutions.

An LED of Reference Example 4 was manufactured in the same manner as a case of Example 1 except that no inorganic filler was added.

Outputs of the respective white LEDs were obtained by the total luminous flux measuring apparatus and white relative values were calculated defining an output of the LED of Example 4 as 1. The results together with the average particle diameters and the additive amounts of the inorganic filler are shown in the following Table 1.

As shown in above Table 1, all the white LEDs of Examples 1 to 11 where fine fillers having an average particle diameter of 0.001 to 1 μm were added in an amount of 0.1 to 25 wt % have high outputs. Since the sealing material is made from an inorganic material, the white LEDs are excellent in heat resistance and are also excellent in the environment resistance property and ultraviolet resistance property. According to the embodiment of the present invention, a semiconductor light-emitting device with a high output which is excellent in heat resistance and is excellent in the environment resistance property and ultraviolet resistance property is provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A semiconductor light-emitting device comprising:
a semiconductor light-emitting element that emits light; and
a sealing material made from an optical transparent inorganic material and provided on the semiconductor light-emitting element, the optical transparent inorganic material containing phosphor particles and inorganic filler, the inorganic filer having an average particle diameter of 0.001 to 1 μm and being dispensed in an amount of 25 wt % or less.

2. The semiconductor light-emitting device according to claim 1, wherein the inorganic filler is contained in the sealing material in an amount of 0.1 wt % or more.

3. The semiconductor light-emitting device according to claim 1, wherein the inorganic filler comprises at least one selected from SiO₂ and TiO₂.

4. The semiconductor light-emitting device according to claim 1, wherein at least 90 wt % of the inorganic filler is SiO₂.

5. The semiconductor light-emitting device according to claim 1, wherein at least 90 wt % of the inorganic material is SiO₂.

6. The semiconductor light-emitting device according to claim 5, wherein the SiO₂ is obtained from alkoxysiloxane.

7. The semiconductor light-emitting device according to claim 6, wherein the alkoxysiloxane is methylsiloxane.

8. The semiconductor light-emitting device according to claim 1, wherein the sealing material coats an upper face and a side face of the semiconductor light-emitting element.

9. The semiconductor light-emitting device according to claim 1, wherein the phosphor particles contains at least one selected from a group consisting of a YAG system: Ce³⁺ and silicates: Eu²⁺.

10. The semiconductor light-emitting device according to claim 1, wherein an average particle diameter of the phosphor particles is in a range of 3 to 80 μm.

11. The semiconductor light-emitting device according to claim 1, wherein the phosphor particles are contained in the sealing material in a concentration of 5 to 80 wt %.

12. The semiconductor light-emitting device according to claim 1, wherein the semiconductor light-emitting element comprises a gallium nitride compound semiconductor that emits light with a wavelength of 365 to 550 nm.

13. The semiconductor light-emitting device according to claim 12, wherein the semiconductor light-emitting element is a blue-color light-emitting diode chip of the GaN-type with a peak of light-emission wavelength of 440 to 470 nm.

14. The semiconductor light-emitting device according to claim 1, further comprising an electrically-conductive base member supporting the semiconductor light-emitting element.

15. The semiconductor light-emitting device according to claim 14, wherein the electrically-conductive base member is a Cu frame.

16. The semiconductor light-emitting device according to claim 14, wherein the electrically-conductive base member has a recess serving as a mount portion.

17. The semiconductor light-emitting device according to claim 14, wherein the sealing material is filled in the mount portion.

18. The semiconductor light-emitting device according to claim 14, wherein the semiconductor light-emitting element is embedded in the sealing material.

19. The semiconductor light-emitting device according to claim 14, further comprising a cover resin sealing material covering the sealing material.
